(19) United States
(12) Patent Application Publication
(10) Pub. No.: US 2016/0320299 A1
(43) Pub. Date: Nov. 3, 2016

(54) ARRAY NEAR-FIELD HIGH OPTICAL SCATTERING MATERIAL DETECTION METHOD

(71) Applicant: NATIONAL APPLIED RESEARCH LABORATORIES, Taipei (TW)

(72) Inventors: Hung Ji HUANG, Taipei (TW); Chi Hung HUANG, Taipei (TW); Sheng Hao TSENG, Taipei (TW); Shih Jie CHOU, Taipei (TW); Rui Cian WENG, Taipei (TW); Shih Yu TZENG, Taipei (TW)

(21) Appl. No.: 14/697,633

(22) Filed: Apr. 28, 2015

(51) Int. Cl. G01N 21/49; G01N 23/04; G01N 21/47; G01N 21/64; G01N 21/65

(52) U.S. Cl. CPC G01N 21/49; G01N 21/6486; G01N 21/65; G01N 21/4738; G01N 23/04; G01N 2201/06113

(57) ABSTRACT

An array near-field high optical scattering material detection method is disclosed, which comprises steps of irradiating an input light onto a high scattering material to generate a diffuse reflection, a diffusion, and a transmission within the high scattering material; reading out an optical energy over different positions on the high scattering material, respectively; forming a two dimensional light intensity distribution data image according to the optical energy over different positions on the high scattering material, respectively; and analyzing an internal composition variation of the high scattering material according to the two dimensional light intensity distribution data image to obtain the internal composition data of the high scattering material. By using the above technical means, the internal composition of the high optical scattering material may be known by detecting the same, and may be successfully applied onto a detection use on the green technology involving the biomedical engineering, chemical engineering, and environmental engineering.

### BACKGROUND OF RELATED ART

1. Technical Field

The present invention relates to an array near-field high optical scattering material detection method, and more particularly to an array near-field high optical scattering material detection method based on a detection of an internal composition of the high optical scattering material.

2. Related Art

Currently, although human beings enjoy an increased life age gradually, the average medical source becomes instead decreased. In view of this, development of medical equipment and technology has formed an important issue. For the medical equipment, many are operated based on a comparison between an optical information inputted and its outputted optical version, which is even taken as a detection mechanism for proving an eye detection result. This may benefit a sick examination task. There already have been some visible image technologies for body detection and diagnosis basis comprises MRI/NMR, X-ray image, ultrasonic image, positron image or optical image technologies, etc. These technologies other than the optical image technology may achieve in some image result regarding internal organs deep in the human body, while the optical image technology is mostly applied on image forming technologies for skin and introscope owing to its limitation on its transmissive depth. In the image forming sense, some particular optical operation methods are employed to spotlight positions associated with sick, including a dark field scattered light image forming, a use of lights with different wavelengths, an application of polarization selection, confocal scan image forming, or high spectrum scan image technologies. In the case of some particular biochemical technologies used together, a fluorescent molecule or particle dying, and metal or non-metal particle dying technologies are employed ascertain the positions where some target sick causing sources are. The optical image forming technology possesses the advantages of online recognition and proving fact. Therefore, this technology features a significant meaning of tissue affection and diagnosis.

Since the optical image forming technology is typically limited on its irradiated depth of the used light, it is mostly applied on skin or organ detection by using the introscope. Skin is a tissue composed of a stack of a huge amounts of cells, and may include an outer skin and an inner skin layers, each having its function. The inner skin layer takes a proportion of above 90% in volume among the total skin, and contains collagen providing the skin with flexibility and supporting effect. The outer skin layer has blood vessels embedded therein, and which may provide nutrients necessary and maintained skin's temperature. On the other hand, the outer skin contains structures such as hair follicle and sweat gland. What included within the inner skin such as the concentration of collagen, haem, oximetry, and the containing amount of some rare material may affect the skin's operation and outlook. In addition, the course of skin's aging or scars' generation, the collagen forming the tissue cells may also vary at its containing amount. In addition, when there is a skin tumor or other inflammation presented, the blood distribution density and the haem concentration may also vary, and the contained water amount and the blood-oxygen concentration associated therewith also vary correspondingly. For detection of the skin, eye and additional auxiliary equipment may be clinically employed to directly or indirectly observe the skin. However, in the case of completely quantizing the cell stacking state and the relationship between the cell stacking state and the associated material concentration, doctors still have to rely upon the invaded tissue biopsy for the accurate evaluation's purpose. For some medically confidential class of information accessed by only doctors or other interior uses, the conventional policies adopt a spectrum method to provide quantized collagen concentration and other physiological data. The associated study may be found from such as Taiwan patent TW102101950 and U.S. patent Ser. No. 13/944,697, where optical fibers arranged equidistantly over a one dimensional space is used as an input light source, and the transmission loss regarding the transmission from the incident light to the receiver optical fibers involving different transmission distance is measured. Since the transmission loss is related with the absorption and light scattering of the material within the skin, the concentration of the material within the skin may be deduced, so that the doctors and patients may perceive the variation regarding the infected portion on the skin in a more objective and rapid manner.

Since it is generally desired to find any skin or tumor's pathological changes at an earlier stage to secure the best medical effect, a hole-body skin scan image forming or a multi-cameras 3D image forming examination are applied for skin image detection. To enhance the recognition ability, different operating lights are used or polarizations are selected to increase the image forming recognition. In image forming on a small area, the confocal microscopic scan image forming, fluorescent scan image forming, polarization selection image forming or high spectrum scan image forming may assist in a spectrum recognition with a high resolution. Since the visible light or infrared light is used as the input light source, the image forming depth based on the above methods may affect the image forming resolution for the deep tissue owing to the complexity of the tissue.

The optical coherence tomography (OCT) is operated based on a software calculation method to provide the information regarding the blood vessels within the deep skin tissue and the real time tissue biopsy, greatly benefiting the detection of the skin's pathological changes. However, this mechanism involves a relatively smaller resolution and a costly equipment, lending to an inappropriate handheld equipment for diagnosis used in a skin clinic store. In addition, some precise optical system is required, and hence some depressed portions or organ portions in the body may not be provided with the image monitoring function.

In view of the above, the equipment used clinically for skin detection still leaves something to be considered, and which will be summarized as follows. 1. The large scaled medical equipment takes up a large space, lending to a high cost of the hospital. 2. The real time image detection involves a display for variations between the outer skin layer and the inner skin layer under some particular physiological condition, and which requires a wait time. 3. The spectrum measurement method requires a huge amount of data to be collected to be used in a spectrum database for reference for the clinic diagnosis and evaluation, the spectrum data being associated with age, sexuality and skin portion. Furthermore, the concentration of collagen within the skin stored in a statistic database has to be analyzed so that it may be taken as a reference for the measured data values. 4. The currently medical technology involves some filling purposes associated with some artificial articles such as silica gel, ceramic or plastic, while these artificial articles may cause the inner skin layer or the muscle within the deep structure to have pathological changes. In addition, the stuff filled into within the skin may have its damage and structure variation issue, and thus it still has to be examined by using a particular equipment before its filling for actual use.

In addition, the organism's internal organs also involve a cell stack as a tissue, including the blood vessel network, the neutral network, etc. And, some partial tissue variation of the inflammation and the sick portion covered within the outer skin layer is similar to the exposed skin portion. In addition, the concept of the internal organ's surface diagnosis may also be conducted in its measurement by using the skin clinic's diagnosis concept.

Nowadays, there has been many non-invaded biomedical optical detection technologies development out for skin diagnosis, such as the chroma meter, the diffuse reflectance spectroscopy (DRS), the laser confocal microscopy, the optical coherence tomography (OCT), and multi-photon microscopy (MPM). The chroma meter is used to produce a RGB color combination for a reflected light signal, and further analyze a proportion of red and black colors to deduce the variations of melanin haem concentrations. However, since the algorithm and measurement technology is more simplified, failing to achieve in a precise and stable result. The laser confocal microscopy and the OCT may acquire information regarding the skin image and structure, but is difficult to directly secure information regarding skin's function.

The MPM technology uses multiple photons to excite a formation of a multi-photon excited fluorescence (TPEF) and a second harmonic generation (SHG) signal, so as to obtain a 3D organism tissue structure image mainly of collagen and elastin. However, this technology involves a relatively costly equipment and requires a relatively longer time period and a relatively larger equipment space, it has a relatively higher use threshold in a clinic skin detection task.

There has been the technology for measuring a containing amount of some particular material by referring to scattering and absorption characteristics of a diffuse reflection light transmitted through the tissue. By providing an irradiation over different positions, the absorption and scattering coefficients associated with any portion of the human skin may be acquired to further deduce various physiological parameters. Taiwan patent 102101950 involves a technology capable of calculating collagen distribution and haem concentration of Keloid, and whose preliminary result has been also published on Journal of Biomedical Optics (JBO), 2012, and applied for a counterpart US patent with its application Ser. No. 13/944,697)).

In this technology, a particular optic fibers detector is used, where a high scattering material has to be laid in front of the light source and the optic fibers to enable the light source to be diverged, so that some optical characteristics of a to-be-measured article may be calculated with the photon diffusion theory considered. The photon diffusion theory transforms the measured reflected light spectrum into some optical parameters of the tissue such as an absorption coefficient (μa) and a scattering coefficient (μs′), where these measured absorption and scattering coefficients are successively used to deduce various physiological parameters for meeting the purpose of some quantized tissue compositions. At present, this technology has been successfully used in some clinical researches, such as detection of optical characteristics of breast, brain, and deep tissues such as muscle, so as to provide some further sickness diagnoses.

In view of the above shortcoming encountered in the prior art, it is required to have a more ideal body detection method to be set forth in the same field.

### SUMMARY

It is, therefore, a main object of the present invention is to provide an array near-field high optical scattering material detection method and apparatus to be served as an auxiliary tool for a preliminary diagnosis for a doctor. The apparatus may exempt from issues of time consumed diagnosis and inconvenient traffic. In addition, the apparatus may be adaptively provided for a preliminary image monitoring and a pathology analysis for a skin at some body's depressed area or an internal organ area.

According to the present invention, the array near-field high optical scattering material detection method comprises steps of irradiating an input light onto a high scattering material to generate a diffuse reflection, a diffusion, and a transmission within the high scattering material; reading out an optical energy over different positions on the high scattering material, respectively; forming a two dimensional light intensity distribution data image according to the optical energy over different positions on the high scattering material, respectively; and analyzing an internal composition variation of the high scattering material according to the two dimensional light intensity distribution data image to obtain the internal composition data of the high scattering material.

By using the above technical means, the present invention may achieve the technical efficacy where the internal composition of the high optical scattering material may be known by detecting the same, and may be successfully applied onto a detection use on the green technology involving the biomedical engineering, chemical engineering, and environmental engineering.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a schematic diagram of a cross sectional state within a high optical scattering material and equipment employed for performing an array near-field high optical scattering material detection method according to the present invention;

FIG. 2 is a schematic diagram of a cross sectional state within the high optical scattering material with another scattering material embedded therein employed for performing the array near-field high optical scattering material detection method according to the present invention;

FIG. 3 is a schematic diagram of a cross sectional state within the high optical scattering material with still another scattering material embedded therein employed for performing the array near-field high optical scattering material detection method according to the present invention;

FIG. 4 is a schematic diagram of a cross sectional state within the high optical scattering material with a fluorescent scattering material embedded therein employed for performing the array near-field high optical scattering material detection method according to the present invention;

FIG. 5 is a schematic diagram of an internal cross sectional state within the high optical scattering material when being irradiated with an input light coming from a particular angle according to the present invention;

FIG. 6 is a schematic diagram of a cross sectional state within the high optical scattering material with a diffuse reflection detection module disposed therein to acquire some material characteristics according to the present invention;

FIG. 7 is a schematic diagram of a cross sectional state within the high optical scattering material with the diffuse reflection detection module disposed therein to acquire some material characteristics according to the present invention;

FIG. 8 is a schematic diagram of a cross sectional state within the high optical scattering material with a separated probe module of an arrayed optical energy read-out module and a separated probe module of the input light source separately disposed on its surface according to the present invention;

FIG. 9 is a schematic diagram of a cross sectional state of the separated probe module of the arrayed optical energy read-out module and the separated probe module of the input light source separately disposed on different planes, associated with the high optical material, according to the present invention;

FIG. 10 is a schematic diagram of a cross sectional state of the arrayed optical energy read-out module with an adaptive contour and the input light source separately disposed on different planes, associated with the high optical material, according to the present invention;

FIG. 11 is a schematic diagram of a cross sectional state of a plurality of such arrayed optical energy read-out module and the input light source separately disposed on different planes, associated with the high optical material, according to the present invention; and

FIG. 12 is a flowchart of the array near-field high optical scattering material detection method according to the present invention.

### DETAILED DESCRIPTION

The present invention will be apparent from the following detailed description, which proceeds with reference to the accompanying drawings, wherein the same references relate to the same elements.

In what follows, an array near-field high optical scattering material detection method disclosed in the present invention will be described first, by which an input light is irradiated into a high optical scattering material and an reflected light from the input light through the high optical scattering material, in which internal composition variations present, is measured and analyzed.

In some material such as a glass, a grit stack, a plastic, a metal particle stack, a ceramic particle, an organism's tissue, or some material dyed previously or adhered with metal particles, the input light is converted into a propagating light in a diffuse reflection form therein owing to a multiple times of scattering generated by the stacked material. As far as the organism's tissue is concerned, it includes the structures such as an outer skin layer, an inner skin layer and a deeper muscle tissue layer.

The other stacked material may also have their stacking mode and diffuse reflection mode. The optical light mode of the propagating light within the high optical scattering material high relates to a sub-material structure composition of the material after the propagating light experience a multiple time of scattering, an absorption, and a long distance diffuse reflection causing by the composition or the sub-material structure. By analyzing the optical mode of the propagating light, the material and the sub-structure composition state within the high optical scattering material may be reversely deduced.

The currently available transmissive organism's tissue detection methods involve a high establishment or operational cost, such MRI/NMR. Some examination equipment may emit some irradiation and should be used within a particularly protected space and involve a limitation of its use times annually. However, this transmissive or soaked detection mechanism may provide a further direct real-time observation and thus has its significant meaning in general clinic examination, and even requires a newer practice.

Furthermore, since the artificial material has been widely used in medical technology such as tooth implant, plastic surgery, or artificial joint technology. In addition, the lactic acid's accumulation in the deep muscle, inflammation on the muscle tissue, or water accumulation at the joint portion may usually affect the body health of the athletic sportsman and general people. Although the higher equipment may provide a more precise examination result, it may be more satisfactory if the equipment may be provided as more simple and convenient and used real time in the clinic examination which may be afforded by general people, and even provided at a side of an athletic field.

When employing the array near-field high optical scattering material detection method, it may be operated on the condition that a gap between a sample and a detector is at least smaller than a wavelength of an operating light, and the light energy of the propagating lights presenting at different positions may be read out by an array optical light read-out device.

Therefore, even the optically transmissive and reflective images of the target material are vague, one may still acquire the image data for analysis, thereby quantization analysis and research on the compositions at the surface or the internal portions of the to-be-measured sample may be conducted.

Next, when it is operated at an optical near-field range, more propagating lights originally restrained within the high optical scattering material may be acquired, a more enhanced quantization analysis and research regarding the surface or the internal compositions of the to-be-measured sample may be achieved

Thirdly, the acquired image data may be further used to launch a Fourier's optical transformation or other image calculations, so that the analysis research and a reverse deduction may be possible to obtain some quantization parameters for expressing the internal sub-structure's composition within the high optical scattering material. Further, a physical, chemical, or biochemical variations on different conditions within the high optical scattering material may be thus analyzed and researched.

Fourthly, the array near-field high optical scattering material detection method also be applied when a non-planar high optical scattering material is encountered, where a small sized or curved array optical energy read-out device may be used to acquire a propagating light strength distribution signal corresponding to some particular positions of the high optical scattering material. Therefore, a particularly structured high optical scattering material may be possible for the material composition detection.

Fifthly, the array near-field high optical scattering material detection method of the present invention may adopt a separation arrangement regarding the input light source and the arrayed optical energy read-out device.

Sixthly, an invaded detection policy is used under some conditions, where the arrayed optical energy read-out device is arranged nearer to the to-be-measured structure to increase a signal strength and an image recognition rate associated with the to-be-detected portion.

Seventhly, since the use requirement is different and it is the array near-field optical energy read-out device acquiring the required image data, the light source is not limited as any particular form. In this invention, the coherent or incoherent irradiated light may be ranged from the X-ray portion to the infrared portion as long as the array optical energy read-out device may be used to receive the signal of the propagating light within the sample in a near field range. In this case, an angle between the input light and the arrayed optical energy read-out device has also no any limitation as long as the gap between the arrayed optical energy read-out device and the sample falls within the near-field optical range.

Eighthly, the arrayed optical energy read-out device may be in a form capable of successively scanning different position space signals and acquiring the near-field optical signal. In the scanning process, the gap between the optical energy read-out device and the sample may be maintained within the near-field optical distance, so as to assure the read-out data may be used for analysis of the overall skin tissue structure.

Ninthly, although the images acquired within the near- and far-field optical range are different, the raw data or the processed data of it for the near field range may be used for analysis of the structure variations of the sample material.

Tenthly, the arrayed optical energy read-out device may not be limited as having a periodic feature as long as the extract positions of the optical energy may be ascertained and the probe and the sample are within the near-field optical range. Such read-out device includes a bundle of optic fibers or optic fibers ranged in a single row with a known pitch for a motion scan record.

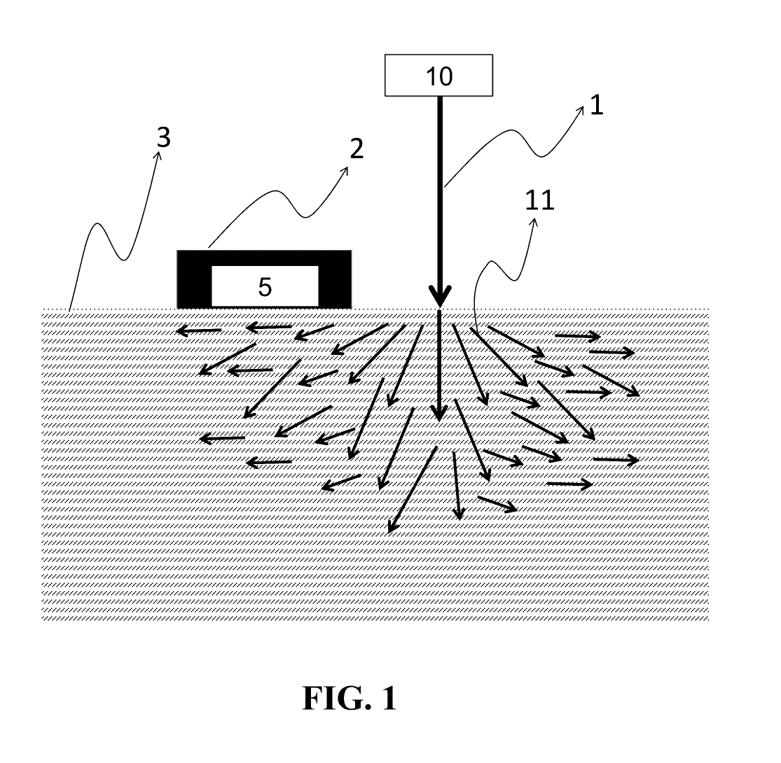

Referring to FIG. 1 through FIG. 11, a schematic diagram of a cross sectional state within a high optical scattering material and equipment employed for performing an array near-field high optical scattering material detection method according to the present invention is shown therein.

As shown in FIG. 1, the equipment comprises an input light source 10 and an arrayed optical energy read-out device 2, and the input light source 10 generates an input light 1. The input light 1 is used to be irradiated onto a high optical scattering material 3 for detecting the high optical scattering material sample 3. When the input light 1 penetrates into the high optical scattering material 3, a diffuse reflection, a diffusion, and a transmission are generated due to the material structure and a propagating light 11 is thus presented.

The arrayed optical energy read-out device 2 has an input end 5, the input end 5 having a gap with respect to the high optical scattering material 3 being required to be smaller than a wavelength of the input light 1. The arrayed optical energy read-out device 2 reads out the optical energy of the propagating light presented at different positions over the high optical scattering material with its optical energy input end 5, thereby a two dimensional light strength distribution data image is obtained. Based on the optical energy obtained over the different positions over the high optical scattering material 3, a composition of the high optical scattering material 3 is analyzed. The input light 1 may be generated by a gas light source or a semiconductor light source. In addition, before the input light 3 reaches the high optical scattering material 3, the input light 1 may also be a single or composite light source having been modulated by an optical element such as a transmissive, a reflective or an optically transmissive interface waveguide, so that the input light 1 itself may meet the requirement of different high optical scattering material 3.

The arrayed optical energy read-out device 2 may read out the high optical scattering material 3 over a plurality of different positions, and which may be twenty in present invention. The arrayed optical energy read-out device 2 may be an arrayed photosensitive coupling photoelectric conversion element or an image detection tool. The arrayed optical energy read-out device 2 may include a multi-channel optical-coupling element (now shown), and may also include optically coupled light energy extract device and am image forming device, where the optically coupled light energy extract device capable of transmitting a light energy from a near-field optical distance range at a surface of the high optical scattering material sample to a far-field distance range.

To further analyze the image data, the two-dimensional light intensity distribution data image from the arrayed optical energy read-out device 2 may be further subjected to an image data processing, such as addition, subtract, multiplication, and division, or Fourier transformation among the image data, or filtering and eliminating a particular special frequency signal, increasing and spotlight a particular special frequency signal, or filtering and eliminating a particular geometrical feature. To present the particular structure within the high optical scattering material 3, the high optical scattering material 3 may be dyed or adhered with metal particles previously or some other manners to enhance an external light interaction response strength of different depth areas, so as to obtain the data image having more information.

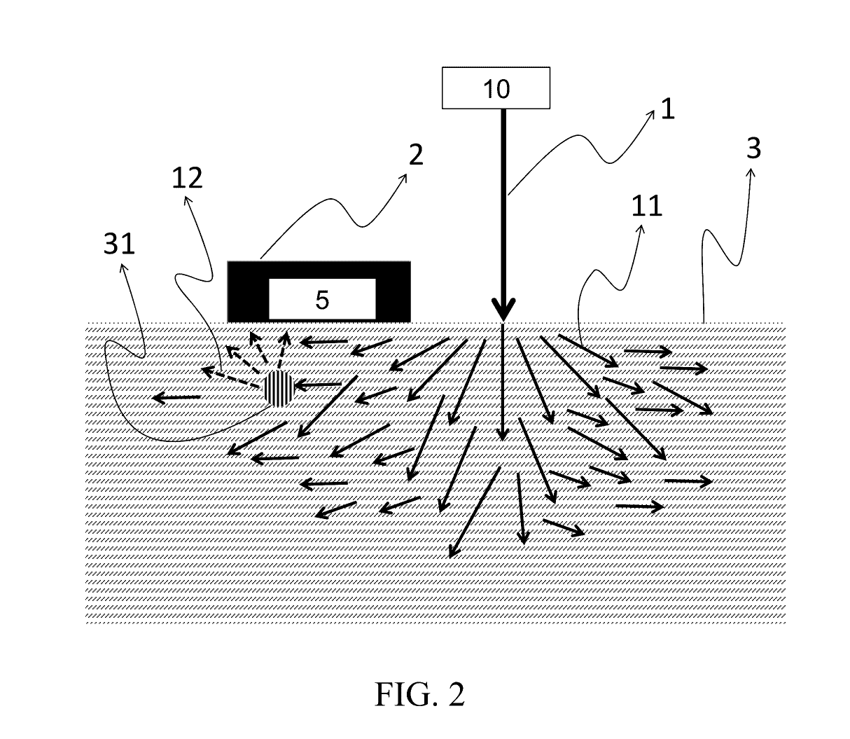

FIG. 2 is a schematic diagram of a cross sectional state within the high optical scattering material with another scattering material embedded therein employed for performing the array near-field high optical scattering material detection method according to the present invention. As shown, the propagating light 11 travelling within the high optical scattering material 3 may cause another scattering light 12 when touching an embedded different scattering material 31 owing to a physical or chemical interaction between them. Therefore, the optical energy input end 5 of the arrayed optical energy read-out device 2 reads out the optical energy coming from the propagating light 11 causing from different positions over the high optical scattering material 3 and the another scattering light 12 causing from the embedded another different material concurrently, and thus form jointly a two dimensional light strength distribution data image.

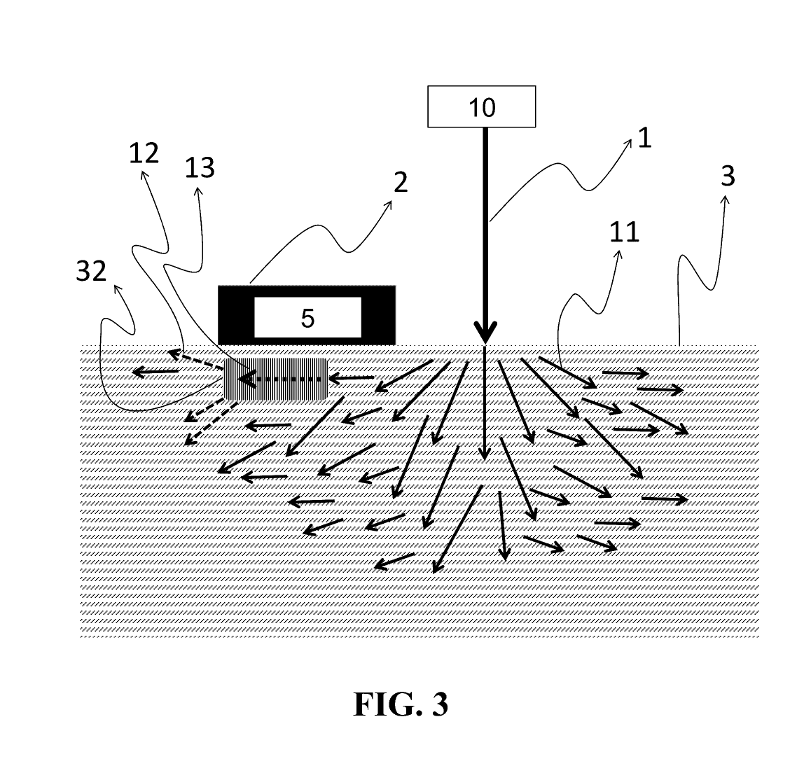

FIG. 3 is a schematic diagram of a cross sectional state within the high optical scattering material with still another scattering material embedded therein employed for performing the array near-field high optical scattering material detection method according to the present invention. As shown, when an embedded larger difference scattering material 32 presents within the high optical scattering material 3, the propagating light 11 travelling within the high optical scattering material 3 may generate the propagating light 11 causing from the embedded larger difference scattering material 32 owing to a touch and thus a physical or chemical interaction between them or a scattering light 12 causing from the embedded different scattering material 31. The different scattering material 31 exists but is not presented in FIG. 3 again, and is located in fact behind the embedded larger difference scattering material 32. The light energy input end 5 of the arrayed optical energy read-out device 2 reads out the propagating light 11 at different positions over the high optical scattering material 3, the scattering light 12 of the embedded different material 31, and the propagating light 31 of the embedded larger difference scattering material 32, to form a two dimensional light strength distribution data image. The propagating light 11, the propagating light 13 or the scattering light 12 are not limited as travelling and diffusing only at a surface area of the high optical scattering material, and thus a state analysis of the high optical scattering material is also not limited at the surface area of the high optical scattering material.

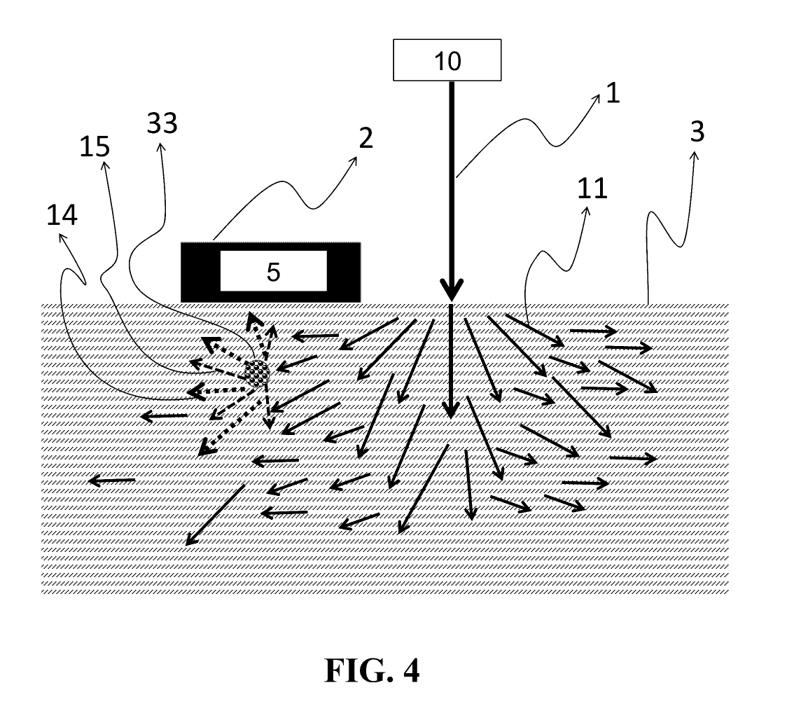

FIG. 4 is a schematic diagram of a cross sectional state within the high optical scattering material with a fluorescent scattering material embedded therein employed for performing the array near-field high optical scattering material detection method according to the present invention. As shown, the propagating light 11 travelling within the high optical scattering material 3 may generate the scattering light 12 causing from the embedded different scattering material owing to the physical or chemical interaction, a scattering light 13 and a fluorescent 15 causing from an embedded fluorescent scattering material. The optical energy input end 5 of the arrayed optical energy read-out device 2 reads out the optical energy corresponding to the propagating light 11 at different positions over the high optical scattering material 3, the scattering light 12 causing from the embedded different scattering material, and a scattering light 14 and the fluorescent 15 coming from the embedded fluorescent scattering material, respectively, and thus form a two dimensional light strength distribution data image. The arrayed near-field optical energy read-out device 2 for measurement has a pixel energy unit comprising a composite unit composed of a plurality of sub-pixel units, so that it may have different photoelectric conversion effect corresponding to different light wavelength. Alternatively, the device 2 has spectrum analysis function element for analyzing the extracted light. At the same time, the input light 1 may focus on a desired to-be-received signal, and enhance a signal response strength of a light having a wavelength other than the wavelength of the input light, so that the a measurement to fluorescent or Raman spectrum response may be enhanced.

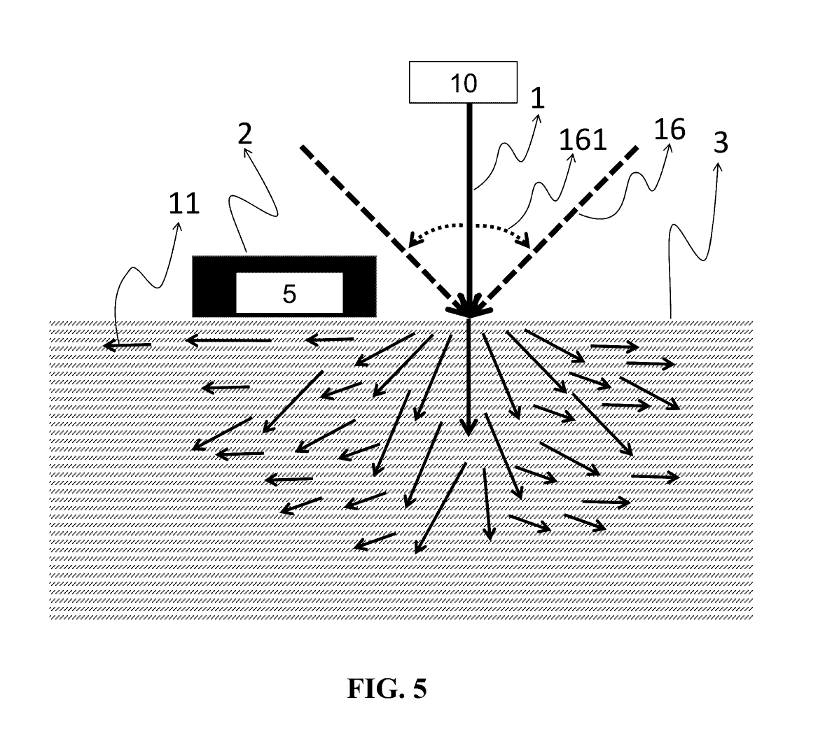

FIG. 5 is a schematic diagram of an internal cross sectional state within the high optical scattering material when being irradiated with an input light coming from a particular angle according to the present invention. As shown, the input light 1 may be provided as an inclined input light 16 at an appropriate angle, so that the optical energy distribution over the different positions on the material 3 may be more significantly presented. In this manner, the two dimensional light strength distribution data image thus obtained may be further appropriate for the analysis.

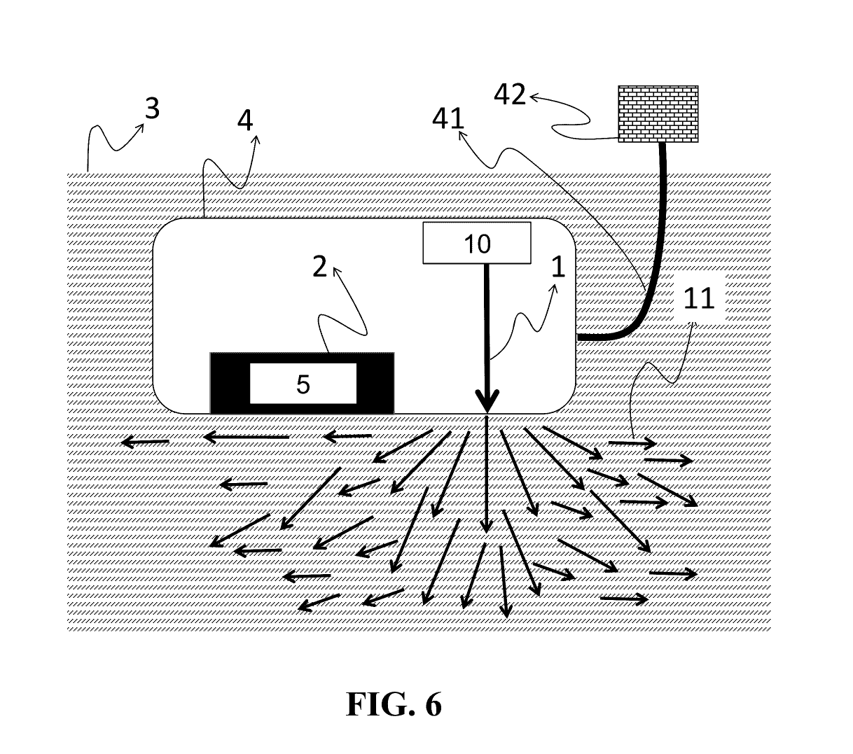

FIG. 6 is a schematic diagram of a cross sectional state within the high optical scattering material with a diffuse reflection detection module disposed therein to acquire some material characteristics according to the present invention. As shown, a diffuse reflection detection head module 6 is immersed in operation into the high optical scattering material 3, so that the material structure and optical characteristics inside the high optical scattering material 3 may be obtained.

The diffuse reflection detection head module 6 transmits an optical ad electronic signal through a connection wire 41 to outside the high optical scattering material 3, under a control of an external controller 42.

FIG. 6 is a schematic diagram of a cross sectional state within the high optical scattering material with a diffuse reflection detection module disposed therein to acquire some material characteristics according to the present invention;

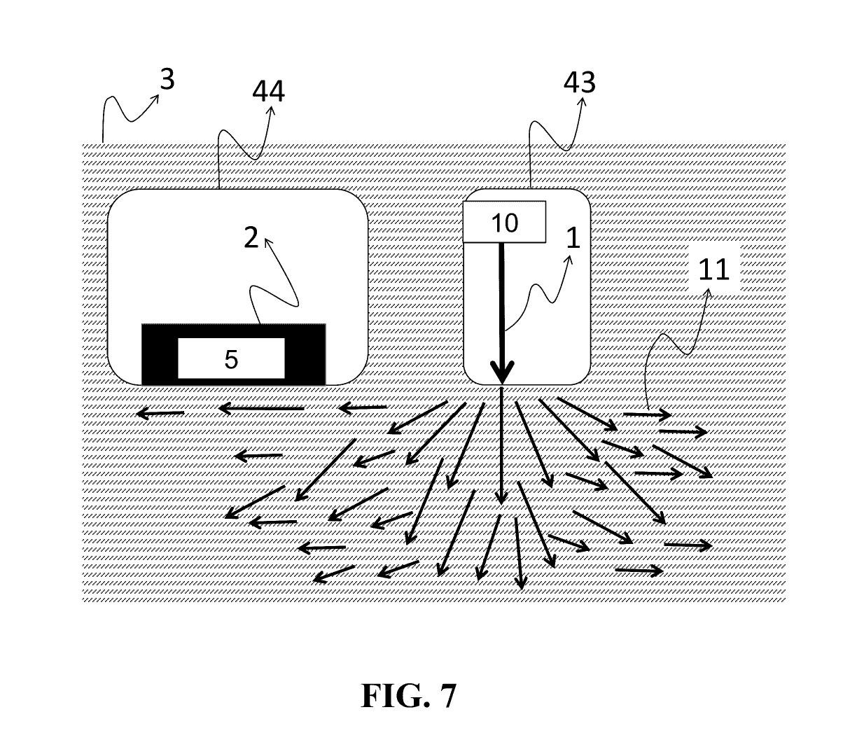

FIG. 7 is a schematic diagram of a cross sectional state within the high optical scattering material with the diffuse reflection detection module disposed therein to acquire some material characteristics according to the present invention. As shown, a probe detection module 423 of the arrayed optical energy read-out device 2 and a probe head module 44 of the input light 1 are separately immersed into the high optical scattering material 3, so as to obtain the material structure and the optical characteristics within the high optical scattering material. Even more, the arrayed optical energy read-out device 2 may achieve in a result of the two dimensional light strength distribution data image being more appropriate for analysis.

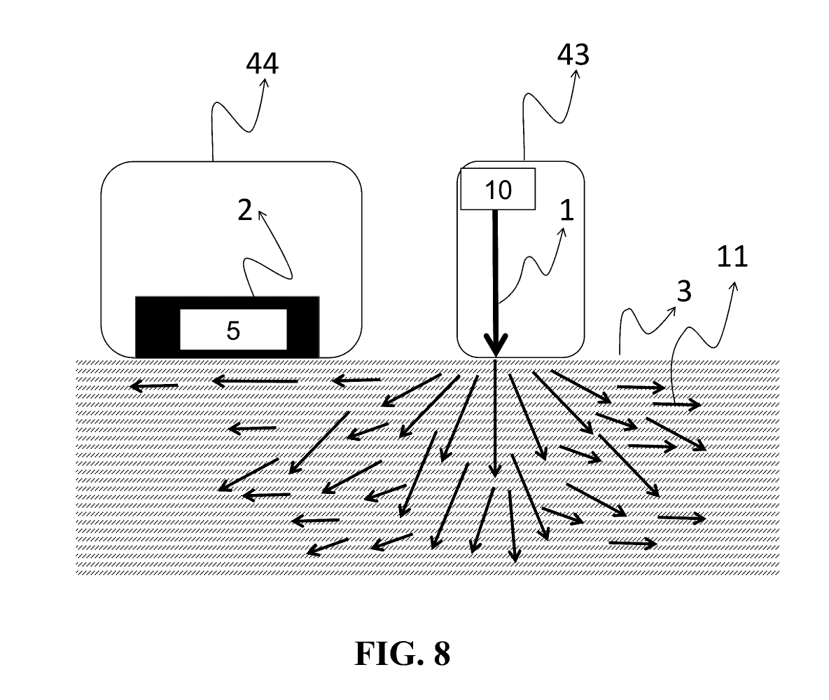

FIG. 8 is a schematic diagram of a cross sectional state within the high optical scattering material with a separated probe module of an arrayed optical energy read-out module and a separated probe module of the input light source separately disposed on its surface according to the present invention. In the measurement, the input light 1 may be arranged over or immersed into inside the high optical scattering material 3, so that the arrayed optical energy read-out device 2 may achieve in a result of the two dimensional light strength distribution data image being more appropriate for analysis.

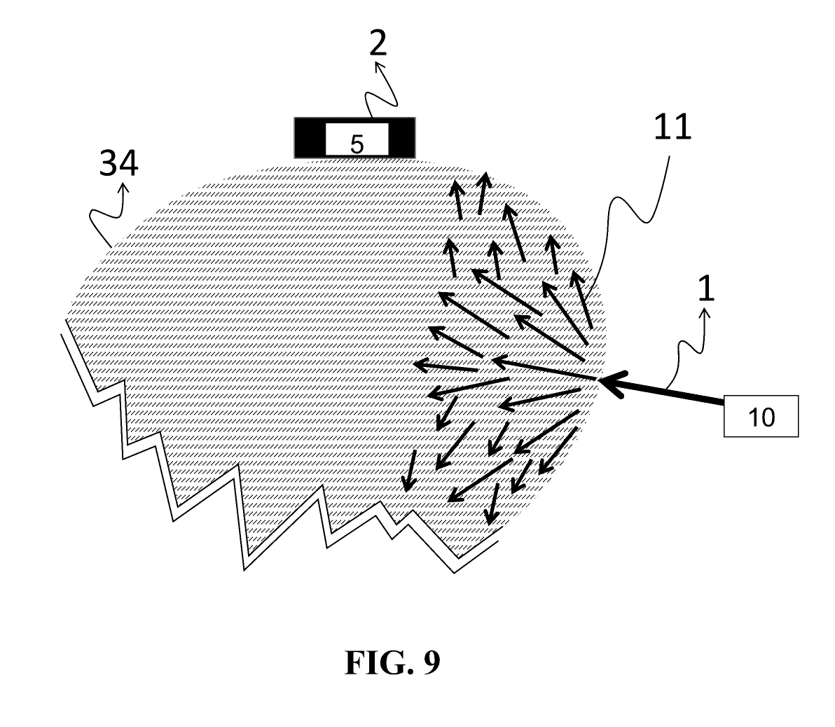

FIG. 9 is a schematic diagram of a cross sectional state of the separated probe module of the arrayed optical energy read-out module and the separated probe module of the input light source separately disposed on different planes, associated with the high optical material, according to the present invention. It may be known through the figure that the input light 1 or an separate input light input device probe head module 44 and the arrayed optical energy read-out device 2 or a separate arrayed optical energy read-out device probe head module 43 may be disposed on different planes, so that they may be used in the case of a non-planar high optical scattering material 3 and thus the material structure and the optical characteristics presented by the propagating light 11 may be obtained. In this manner, the arrayed optical energy read-out device 2 may achieve in a result of the two dimensional light strength distribution data image being more appropriate for analysis.

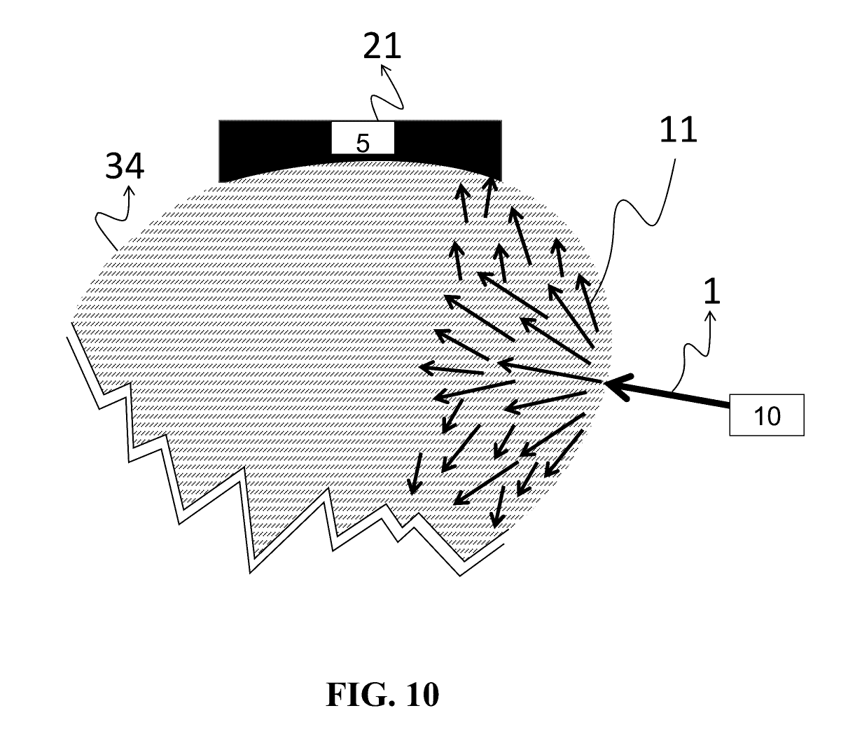

FIG. 10 is a schematic diagram of a cross sectional state of the arrayed optical energy read-out module with an adaptive contour and the input light source separately disposed on different planes, associated with the high optical material, according to the present invention. In this case, the arrayed optical energy read-out device 21 has an adaptive contour, so that the arrayed optical energy read-out device 2 may achieve in a result of the two dimensional light strength distribution data image being more appropriate for analysis.

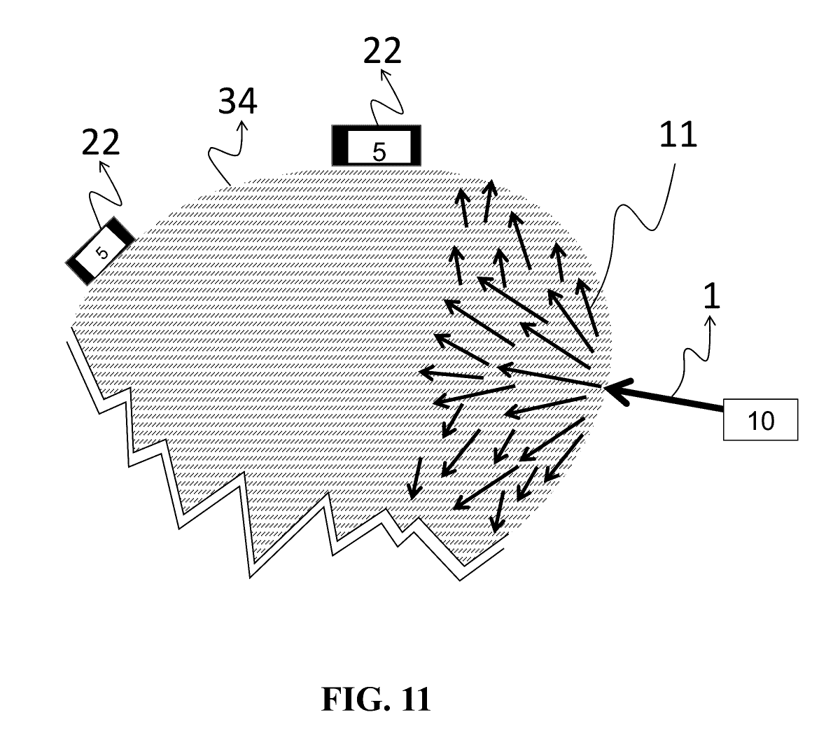

FIG. 11 is a schematic diagram of a cross sectional state of a plurality of such arrayed optical energy read-out module and the input light source separately disposed on different planes, associated with the high optical material, according to the present invention. As shown, the arrayed optical energy read-out device 2 is provided as having the plurality of such device, so as to achieve in a result of the two dimensional light strength distribution data image being more appropriate for analysis.

In addition, the optical element used in the equipment is required to be such one requiring to be applied with an appropriate shape alternation if necessary or such one requiring an modulated light path to completely collect the light energy. And, all the optical elements are introduced to appropriately increase a structurally supported mechanical assembly. Some other auxiliary elements undescribed herein are not to be deemed as a limitation of the present invention.

In this invention, the high scattering material is selected from a group consisting of an organism tissue, a plastic material, a ceramic material, a laminating material, and the like.

The laminating material may be a glass, a grit, a plastic, a metal particle, a ceramic particle, a microorganism, and the glass, the grit, the plastic, the metal particle, the ceramic particle, and the microorganism adhered with a chemical or an organism material.

The stack material has a curved surface or an irregular shape other than a flat surface and has a main basic material formed by the organism tissue comprising a plurality of artificial material, wherein the artificial material may be the glass, the grit, the plastic, the metal particle, the ceramic particle, and the microorganism in a stacking form. Therefore, the present invention may be applied onto the biomedical engineering, chemical engineering, and environmental engineering.

Since the high optical scattering material and the non-planar high optical scattering material 34 are merely measured objects and thus the measured sample may take other shapes, the scope of the present invention is not construed as the described measured objects herein.

Since the non-planar high optical scattering material 34 is merely a measured object and the actual measured object may be very complicate in shape, a distance of each light energy read-out pixel unit of the arrayed near-field optical energy read-out device 2 to the non-planar high scattering material 34 may not be maintained totally within the near-field optical range, even though the adaptive shape of the arrayed near-field optical energy read-out device 2 is used, other shapes of the non-planar high optical scattering material 34 may be detected conceptually under the same technical spirit. In this case, it should be noted that the detection method of the present invention may be used with some small operating variation and still deemed as falling within the scope of the present invention.

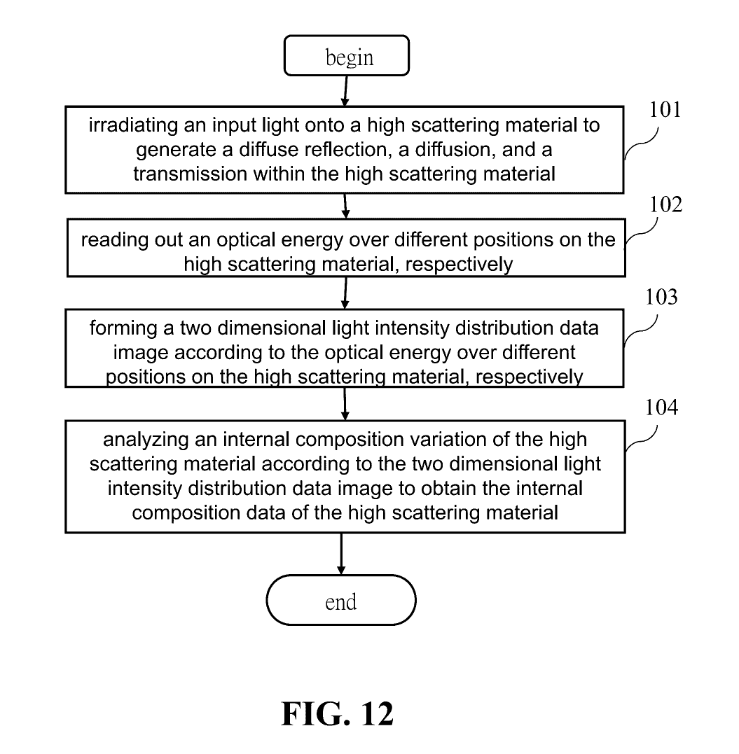

Thereafter, the array near-field high optical scattering material detection method of the present invention will be described with reference to FIG. 12, in which a flowchart of the method according to the present invention is illustrated.

At first, an input light is irradiated onto a high scattering material to generate a diffuse reflection, a diffusion, and a transmission within the high scattering material (S101). Next, an optical energy over different positions on the high scattering material is read out, respectively (S102). Thereafter, a two dimensional light intensity distribution data image according to the optical energy over different positions on the high scattering material, respectively (S103). Finally, an internal composition variation of the high scattering material is analyzed according to the two dimensional light intensity distribution data image to obtain the internal composition data of the high scattering material (S104).

By means of the above technical means, the present invention may achieve in the technical efficacy of detection of the material structure of the high optical scattering material by using the optical principle, whereby solving the issue encountered in the prior art.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An array near-field high optical scattering material detection method, comprising steps of:
irradiating an input light onto a high scattering material to generate a diffuse reflection, a diffusion, and a transmission within the high scattering material;
reading out an optical energy over different positions on the high scattering material, respectively;
forming a two dimensional light intensity distribution data image according to the optical energy over different positions on the high scattering material, respectively; and
analyzing an internal composition variation of the high scattering material according to the two dimensional light intensity distribution data image to obtain the internal composition data of the high scattering material.

2. The array near-field high optical scattering material detection method as claimed in claim 1, wherein the input light is a monochromatic light source selected from a group consisting of an X-ray light source, a gas light source, a semiconductor light source, and a laser light source, modulated by an optical element, or a composite light source selected from a combination within the group after being modulated, the combination comprising at least one monochromatic light source, wherein the optical element is a transmissive optical element, a reflective optical element, or an optically transmissive interface waveguide.

3. The array near-field high optical scattering material detection method as claimed in claim 1, wherein the step of reading out an optical energy over different positions on the high scattering material, respectively, further comprises steps of:
reading out the optical energy over a plurality of different positions on a one dimensional array on the high scattering material, respectively; and
reading out the optical energy over at least twenty equidistant positions on the one dimensional array on the high optical scattering material.

4. The array near-field high optical scattering material detection method as claimed in claim 1, wherein the step of analyzing the internal composition variation of the high scattering material according to the two dimensional light intensity distribution data image further comprises steps of:
applying an image data processing to analyze the two dimensional light intensity distribution data image according to the two dimensional light intensity distribution data image, wherein the image data processing comprises an operational processing including a geometrical operation and a Fourier transformation over a plurality of pixels obtained by a plurality of different test settings, an operational processing for filtering and eliminating a specific special frequency signal, an operational processing for enhancing the specific special frequency, and an operational processing for filtering and eliminating a specific geometrical feature.

5. The array near-field high optical scattering material detection method as claimed in claim 1, wherein the step of analyzing the internal composition variation of the high scattering material according to the two dimensional light intensity distribution data image further comprises steps of:
applying an image data processing to analyze the two dimensional light intensity distribution data image according to the two dimensional light intensity distribution data image, wherein the image data processing is a spectrum analysis to obtain an image spectrum response data to filter out a signal of the input light and enhancing a signal response intensity of a light having a wavelength otherwise a wavelength of the input light, to analyze a fluorescent response or a Raman spectrum response of the high scattering material or a deep area of the high scattering material.

6. The array near-field high optical scattering material detection method as claimed in claim 5, wherein the input light has a conductive and diffusive path being located on one of the high scattering material and an area outside a surface area of the high scattering material, and the composition analysis of the high scattering material is also applied onto the area outside the surface area of the high scattering material.

7. The array near-field high optical scattering material detection method as claimed in claim 1, wherein the high scattering material is color dyed previously or adhered with a plurality of metal particles to enhance an applied light interaction response speed of a plurality of different deep areas within the high scattering material to enable the two dimensional data.

8. The array near-field high optical scattering material detection method as claimed in claim 1, wherein the high scattering material is selected from a group consisting of an organism tissue, a plastic material, a ceramic material, and a laminating material.

9. The array near-field high optical scattering material detection method as claimed in claim 8, wherein the laminating material comprises a material formed by a stacking or floating on a liquid, and is selected from a group consisting of a glass, a grit, a plastic, a metal particle, a ceramic particle, a microorganism, the glass, the grit, the plastic, the metal particle, the ceramic particle, and the microorganism adhered with a chemical or an organism material.

10. The array near-field high optical scattering material detection method as claimed in claim 8, wherein the stack material has a curveted surface or an irregular shape other than a flat surface and has a main basic material formed by the organism tissue comprising a plurality of artificial material selected from a group consisting of the glass, the grit, the plastic, the metal particle, the ceramic particle, and the microorganism in a stacking form.
